(19) United States
(12) Patent Application Publication
(10) Pub. No.: US 2026/0103012 A1
(43) Pub. Date: Apr. 16, 2026

(54) IMAGE FORMING APPARATUS, IMAGE FORMING METHOD, AND STORAGE MEDIUM

(71) Applicant: Konica Minolta, Inc., Tokyo (JP)

(72) Inventor: Shinya MIYAZAWA, Tokyo (JP)

(21) Appl. No.: 19/352,543

(22) Filed: Oct. 8, 2025

(30) Foreign Application Priority Data
Oct. 10, 2024 (JP) 2024-177557

(51) Int. Cl. B41J 29/393; B41J 11/00

(52) U.S. Cl. CPC B41J 29/393; B41J 11/003; B41J 2029/3935

(57) ABSTRACT

An image forming apparatus includes: an image former that forms an image on a recording medium; a reader that reads the image formed on the recording medium; a colorimeter that performs colorimetry of the image formed on the recording medium; and a hardware processor. Based on image data of multiple color patches obtained from the reader, the hardware processor inspects each of the color patches for an abnormality. Based on the inspection result, the hardware processor determines whether the colorimeter can perform colorimetry of each of the color patches. The hardware processor causes the image former to re-form only a color patch determined not to be subjected to colorimetry by the colorimeter.

### CROSS-REFERENCE TO RELATED APPLICATIONS

The entire disclosure of Japanese Patent Application No. 2024-177557 filed on October 10, 2024, is incorporated herein by reference in its entirety.

### BACKGROUND OF THE INVENTION

### TECHNICAL FIELD

The present disclosure relates to an image forming apparatus, an image forming system, an image forming method, and a storage medium.

### DESCRIPTION OF THE RELATED ART

To form an image with high color reproducibility, a conventional image forming apparatus including an image forming section performs a colorimetry process. In the colorimetry process, color patches are formed on a recording medium; the color patches are read by a predetermined reading device; and correction values for images to be formed by the image forming section are calculated.

In such a control, when the formed color patches include an image defect (e.g., a stain or a streak), an error occurs in the reading result by the reading device. Japanese Unexamined Patent Publication No. 2016-104544 describes an image forming apparatus that forms multiple color patches in a conveyance direction on a recording medium and causes a first image detection section in the upstream of the conveyance direction to read the color patches. The image forming apparatus then causes a second image detection section in the downstream of the conveyance direction to read the color patches that are determined to have no image defect, based the result of reading by the first image detection section. According to such a configuration, when part of the color patches read by the first image detection section among the formed color patches have image defects, for example, the image forming apparatus can cause the second image detection section to read normal color patches and calculate image correction values.

### SUMMARY OF THE INVENTION

However, JP2016-104544A does not describe how to recover the color patches in which defects are found. Therefore, the image forming apparatus may not be able to efficiently perform colorimetry of necessary color patches.

The present disclosure has been made in consideration of such circumstances. An object of the present invention is to provide an image forming apparatus, an image forming method, and a storage medium that can efficiently perform colorimetry of necessary color patches.

To achieve at least one of the abovementioned objects, according to an aspect of the present invention, an image forming apparatus reflecting one aspect of the present invention includes: an image former that forms an image on a recording medium; a reader that reads the image formed on the recording medium; a colorimeter that performs colorimetry of the image formed on the recording medium; and a hardware processor, wherein: based on image data of multiple color patches obtained from the reader, the hardware processor inspects each of the color patches for an abnormality, based on the inspection result, the hardware processor determines whether the colorimeter can perform colorimetry of each of the color patches, and the hardware processor causes the image former to re-form only a color patch determined not to be subjected to colorimetry by the colorimeter.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a side sectional view of an image forming apparatus;

FIG. 2 is a block diagram of the image forming apparatus;

FIG. 3 is a top view of an example of a recording medium on which multiple color charts are formed in a conveyance direction;

FIG. 4 is a top view of an example of a recording medium on which multiple color charts are formed in a width direction;

FIG. 5 is a top view illustrating another example of a recording medium on which multiple color charts are formed in the conveyance direction; and

FIG. 6 is a flowchart of a colorimetry process.

### DETAILED DESCRIPTION

Hereinafter, one or more embodiments of the present invention will be described with reference to the drawings. However, the scope of the invention is not limited to the disclosed embodiments.

The following description describes one or more embodiments of the present disclosure with reference to the drawings. The effects and features of the embodiment of the present disclosure will be understood from the following detailed description and the drawings. The following detailed description and drawings are provided for illustration only and do not limit the scope of the present disclosure.

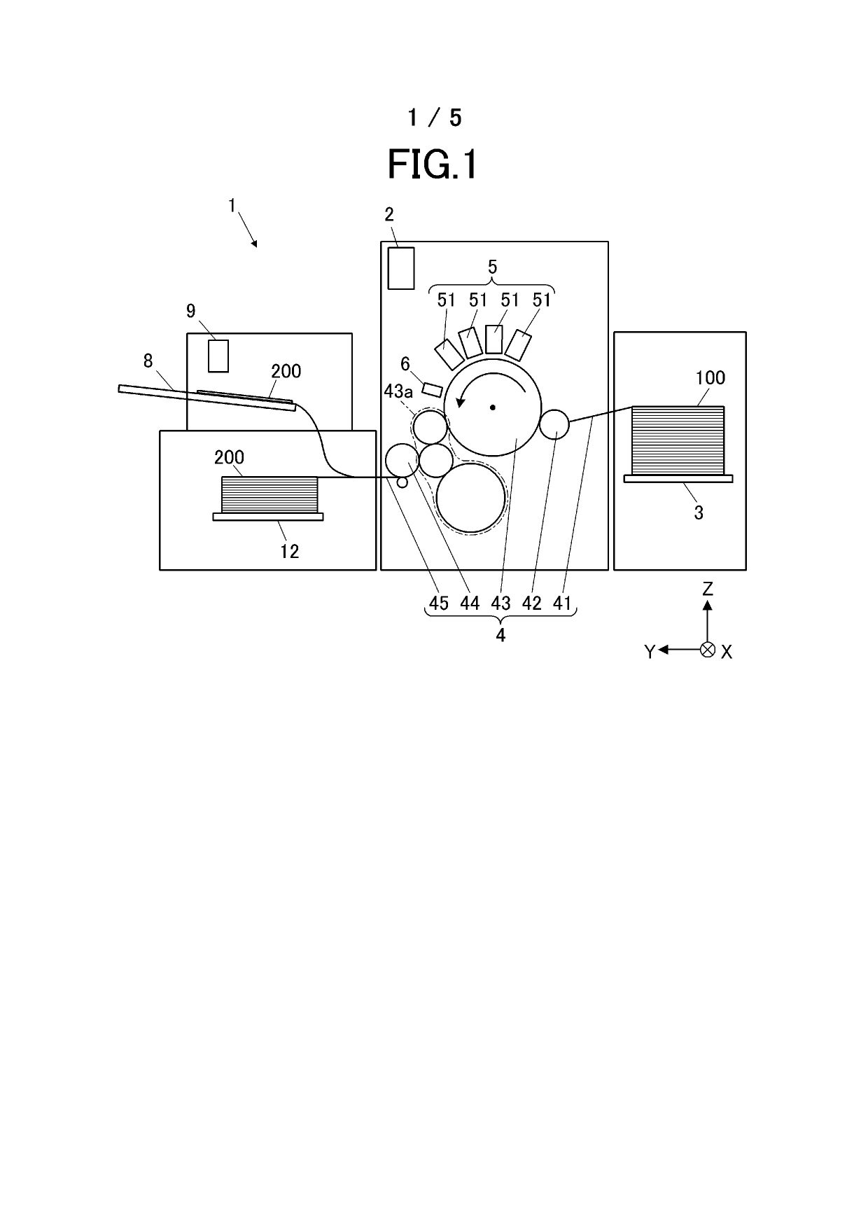

Hereinafter, X, Y, and Z directions are directions illustrated in FIG. 1. In the following description, the X direction, the Y direction, and the Z direction are also referred to as a width direction, a conveyance direction, and a height direction, respectively.

### (Overall Configuration of Image Forming Apparatus)

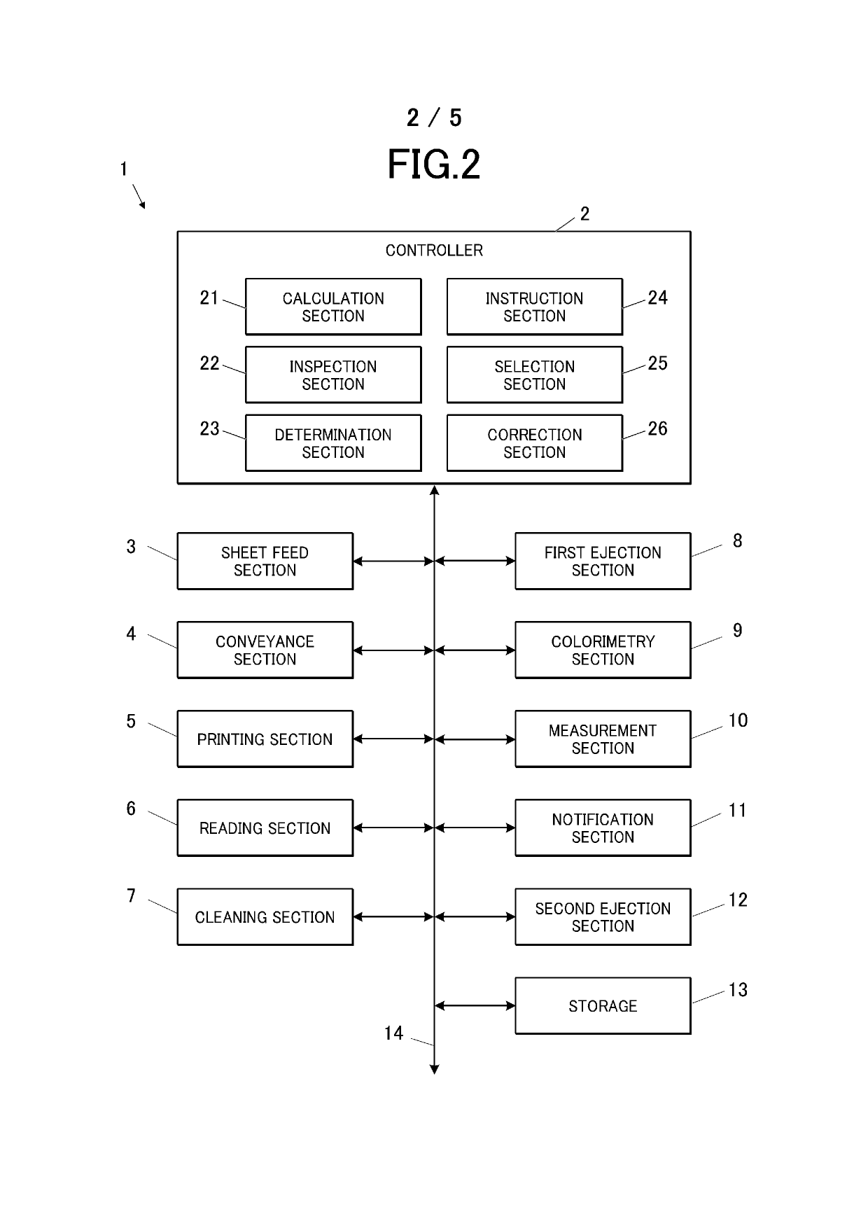

FIG. 1 is a schematic configuration of an image forming apparatus 1 according to the present embodiment. FIG. 2 is a block diagram illustrating a functional configuration of the image forming apparatus 1 according to the present embodiment. In the following description, the image forming apparatus 1 is an inkjet recording apparatus in which an image forming section 5 (i.e., image former) described later includes a plurality of inkjet heads and forms an image on a recording medium 100 by the inkjet recording method.

The image forming apparatus 1 includes the image forming section 5. As illustrated in FIG. 1, the image forming apparatus 1 includes a controller 2 (hardware processor), a sheet feed section 3, a conveyance section 4, a reading section 6 (i.e., reader), a first ejection section 8, a colorimetry section 9 (i.e., colorimeter), and a second ejection section 12. In addition, as illustrated in FIG. 2, the image forming apparatus 1 may include a cleaning section 7, a measurement section 10, a notification section 11, a storage 13, and a bus 14.

### (Recording Medium)

The recording medium 100 can be any kind of medium on which ink having landed on the surface can be fixed. Examples of the recording medium 100 include paper, textiles, and sheet resin. In a case where the recording medium 100 is paper, examples thereof include plain paper and coated paper. Preferably, the recording medium 100 is a flat cut sheet.

### (Sheet Feed Section)

The sheet feed section 3 includes, for example, a tray for storing the conveyed recording medium 100 and stores the recording medium 100 in the tray. As described above, multiple kinds of media can be used as the recording medium 100. Although FIG. 1 illustrates the case where the sheet feed section 3 includes only one tray, the sheet feed section 3 may include multiple trays for storing multiple kinds of recording medium 100 so that any recording medium 100 can be used in accordance with an instruction.

### (Conveyance Section)

The conveyance section 4 conveys the recording medium 100 in a conveyance direction. As illustrated in FIG. 1, the conveyance section 4 includes, for example, a feeder board 41, a first handover drum 42, a conveyance drum 43, a second handover drum 44, and a delivery section 45.

### (Feeder Board, First Handover Drum)

The feeder board 41 conveys the recording medium 100 from the sheet feed section 3 to the first handover drum 42. The first handover drum 42 holds and picks up one end of the recording medium 100 conveyed by the feeder board 41, and hands over the recording medium 100 to the conveyance drum 43.

### (Conveyance Drum)

The conveyance drum 43 has a columnar shape. The side circumferential surface of the conveyance drum 43 is a conveyance surface that attracts and holds the recording medium 100. The conveyance drum 43 rotates in the conveyance direction on a central axis extending in the width direction as a rotation axis while holding the recording medium 100 on the conveyance surface. Thus, the conveyance drum 43 conveys the recording medium 100 attracted to and held by the conveyance surface along the conveyance surface.

The conveyance drum 43 further includes a reversing mechanism 43a in the downstream of the reading section 6 in the conveyance direction. The reversing mechanism 43a reverses the printed material 200 and causes the conveyance drum 43 to convey the printed material 200 again in the conveyance direction, so that the back surface (second surface) opposite the front surface (first surface) of the printed material 200 passes through the image forming section 5. Since the conveyance section 4 includes such a reversing mechanism 43a, images can be formed not only on the front surface but also on the back surface of the printed material 200.

### (Second Handover Drum)

The second handover drum 44 holds one end of the printed material 200 conveyed by the conveyance drum 43, picks up the printed material 200, and hands over the printed material 200 to the delivery section 45.

### (Delivery section)

The delivery section 45 is a delivery path for the printed material 200 and conveys the printed material 200 to an ejection section, such as the first ejection section 8 or the second ejection section 12. The delivery section 45 is constituted by a belt and a roller, for example. When multiple ejection sections are provided, for example when the image forming apparatus 1 includes the second ejection section 12 in addition to the first ejection section 8, the delivery path of the delivery section 45 may be branched in the middle as shown in FIG. 1.

### (Image Forming Section)

The image forming section 5 forms an image on the recording medium 100, based on the image data acquired from the controller 2. The image forming section 5 includes one or more arranged head units 51 each having a length (width) to cover the entire recording medium 100. That is, the image forming section 5 produces the printed material 200 by the one pass method (single-pass method or line head method).

### (Head unit)

The head units 51 each include one or more inkjet heads. The head unit 51 has an ink ejection face at a position facing the conveyance surface of the conveyance drum 43. The head unit 51 forms an image by ejecting ink onto the recording medium 100 held by the conveyance drum 43 at appropriate timing corresponding to the rotation of the conveyance drum 43, thereby producing the printed material 200.

In the image forming apparatus 1 illustrated in FIG. 1, four head units 51 are arranged at a predetermined interval in order from the upstream in the rotation direction of the conveyance drum 43. The four head units 51 eject ink of four colors, for example, yellow (Y), magenta (M), cyan (C), and black (K).

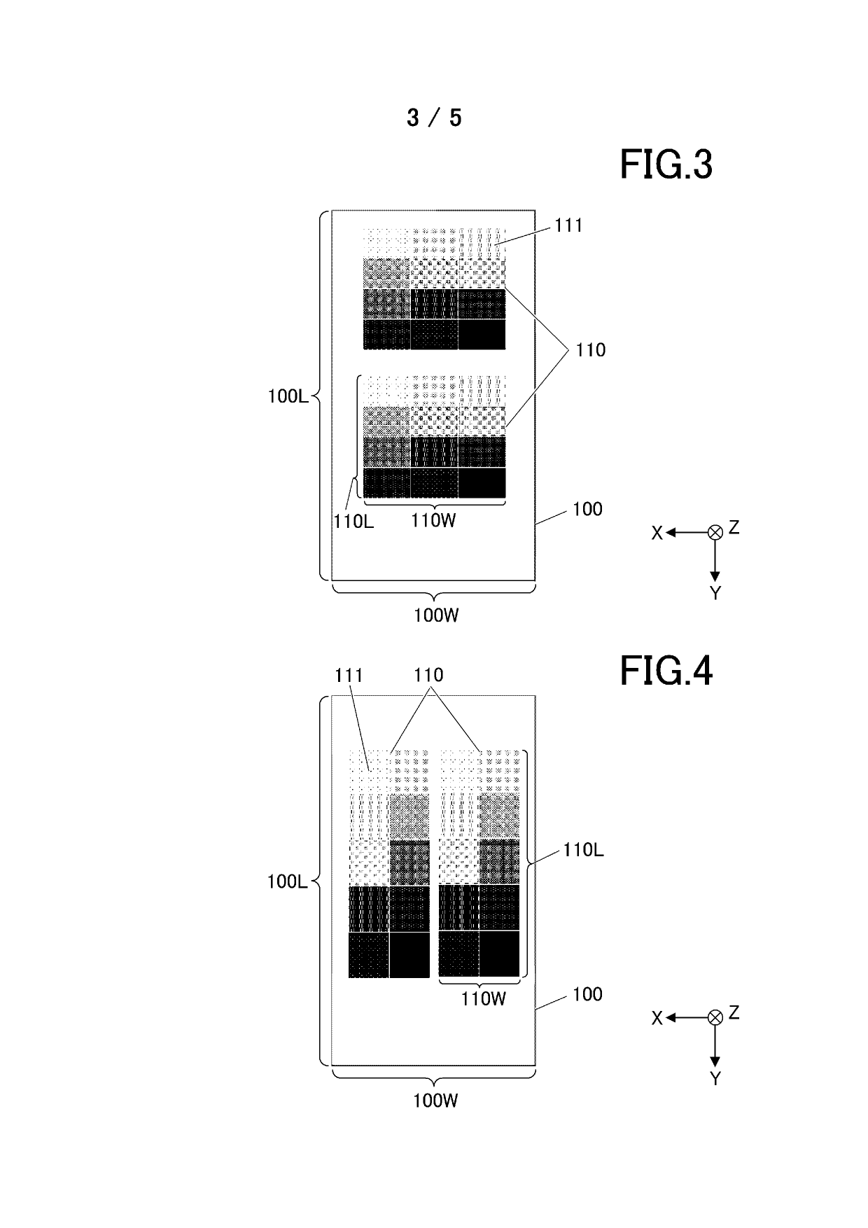

The image forming section 5 performs a normal job, a colorimetry job, and so forth. The normal job is a print job for forming a normal image that is not subjected to colorimetry on the recording medium 100. The colorimetry job is a print job of forming a color chart(s) 110 (see FIG. 3) that is subjected to colorimetry on the recording medium 100.

The color chart 110 is an image for detecting color deviation of the image forming section 5. The color chart 110 includes multiple color patches 111 (see FIG. 3) having different tone values of, for example, primary colors (C, M, Y, and K) and secondary colors (mixtures of primary colors).

### (Reading Section)

The reading section 6 emits light from a light source to the printed material 200 and reads the reflected image. The reading section 6 consists of, for example, an in-line sensor in which multiple detection elements are arranged along the width direction of the recording medium 100 in the image forming apparatus 1. The image read by the reading section 6 (read image data) is sent to the inspection section 22 (described later) of the controller 2, and an inspection process is performed.

### (Cleaning Section)

The cleaning section 7 performs cleaning of the head units 51 as maintenance. For example, the cleaning section 7 is provided at the side of the conveyance drum 43 in the width direction. The cleaning section 7 performs cleaning of the head unit 51 that has moved in the width direction. Examples of the cleaning include wiping for removing ink on the ink ejection face and purging for ejecting ink in ink channels.

### (First Ejection Section)

The printed material 200 is ejected to the first ejection section 8. The first ejection section 8 includes, for example, a tray for storing the printed material 200 and the colorimetry section 9.

### (Colorimetry Section)

The colorimetry section 9 is, for example, an inline colorimeter located above the first ejection section 8. The colorimetry section 9 performs a colorimetry process. Specifically, the colorimetry section 9 performs colorimetry of the printed material 200 that is stationary in the first ejection section 8 under the control of the controller 2. Colorimetry is to measure color information, for example, to measure color values, such as L^{*}a^{*}b^{*} values. The colorimetry section 9 may be a spectral colorimeter that disperses reflected light from the printed material 200 and performs colorimetry, for example.

According to a conventional printing apparatus in which a colorimeter is provided above the conveyance path of printed materials, the apparatus must wait until color values become stable for colorimetry and cannot perform subsequent jobs, such as print jobs and maintenance. This leads to low printing efficiency. On the other hand, according to the image formation apparatus 1, colorimetry is performed by the colorimetry section 9 at the first ejection section 8. According to such a configuration, it is possible to perform other works, such as next print job or maintenance, while waiting for colorimetry or while performing colorimetry. Thus, colorimetry and printing can be efficiently performed.

Further, since the colorimetry section 9 (colorimeter) is not installed outside the image forming apparatus 1 but included in the image forming apparatus 1, the apparatus 1 can easily control the printing process and the colorimetry process.

Since colorimetry is performed for the stationary printed material 200, accuracy of colorimetry improves as compared with a case where colorimetry is performed for the moving printed material 200.

Note that "colorimetry of the stationary printed material 200" according to the present disclosure includes repetition of (i) performing colorimetry of part of the stationary printed material 200 and (ii) moving the printed material 200.

For example, first, the colorimetry section 9 performs colorimetry of the first row in the conveyance direction of the stationary printed material 200 while moving (scanning) in the width direction of the printed material 200. The row of the printed material 200 is a range in which the colorimetry section 9 can perform colorimetry by one time of scanning. After colorimetry of the first row of the printed material 200 ends, the printed material 200 is moved by one row in the first ejection section 8. The colorimetry section 9 performs colorimetry of the second row adjacent to the first row in the conveyance direction of the stationary printed material 200 while moving (scanning) in the width direction of the printed material 200. After colorimetry of the second row in the conveyance direction of the printed material 200 ends, the printed material 200 is moved again by one row in the first ejection section 8.

As described above, according to the present disclosure, colorimetry of the stationary printed material 200 need not be completed at once but may be performed while the printed material 200 is repeatedly stopped and moved.

The color values of the printed material 200 ejected to the first ejection section 8 may not become stable quickly owing to wet ink, for example. Therefore, the colorimetry process may be performed a predetermined colorimetry standby time after the printed material 200 is ejected to the first ejection section 8.

The colorimetry standby time may be adjusted according to at least one of the paper type and paper thickness of the printed material 200, the ink type, image density, and ink amount. The ink amount may be the ink amount of the entire printed material 200 or the maximum ink amount per unit area of the printed material 200. The colorimetry standby time may be adjusted according to at least one of the surface temperature of the printed material 200 in printing, the temperature of the first ejection section 8, and the humidity of the first ejection section 8. The adjustment of the colorimetry standby time may be performed by the user or may be performed under the control of the controller 2.

### (Measurement Section)

The measurement section 10 is provided near the first ejection section 8 and measures the temperature and/or humidity of the first ejection section 8. The temperature and/or humidity of the first ejection section 8 measured by the measurement section 10 is used to adjust the colorimetry standby time, for example.

### (Notification Section)

The notification section 11 notifies colorimetric information obtained by the colorimetry section 9 by displaying the colorimetric information on a display, for example. The colorimetric information notified by the notification section 11 is, for example, information indicating whether variations in color values of the printed material 200 exceed an allowable value.

### (Second Ejection Section)

The printed material 200 is ejected to the second ejection section 12. The second ejection section 12 is separately provided from the first ejection section 8. The second ejection section 12 includes, for example, a tray for storing the printed material 200. In a case where the image forming apparatus 1 includes the second ejection section 12 in addition to the first ejection section 8, the first ejection section 8 receives only the printed material 200 to be subjected to colorimetry, and the second ejection section 12 receives a normal printed material 200 not to be subjected to colorimetry.

### (Controller)

The controller 2 controls operation of other functional components according to print image data, print setting, and so forth. The controller 2 is a computer and includes, for example, a central processing unit (CPU), a random-access memory (RAM), and a read-only memory (ROM). The CPU executes various control programs to drive and control the image forming apparatus 1 and performs various arithmetic processing. The RAM provides a working memory space for the CPU and stores temporary data.

The RAM may include a non-volatile memory. The ROM stores various control programs to be executed by the CPU, setting data, and so forth. Instead of the ROM, a rewritable nonvolatile memory, such as a flash memory, may be used.

When the CPU executes a program, the controller 2 as a hardware processor functions as the calculation section 21, the inspection section 22, the determination section 23, the instruction section 24, the selection section 25, and the correction section 26.

### (Calculation Section)

In the colorimetry process to be described later, the calculation section 21 acquires the length of the recording medium 100 on which the color patch(es) 111 is to be formed and the length of one color patch 111 from the storage 13, for example. Based on the acquired data of these lengths, the calculation section 21 calculates the number of color patches 111 that can be formed on the recording medium 100. Then, based on the calculated number of color patches 111 that can be formed on the recording medium 100, the calculation section 21 calculates the number of color charts 110 that can be formed on the recording medium 100.

The length in the conveyance direction of one color chart 110 to be formed is defined as 110L. The length in the conveyance direction of the recording medium 100 is defined as 100L. As illustrated in FIG. 3, assume that the ratio of 100L to 110L is equal to or greater than a predetermined integer (2), for example. In this case, the calculation section 21 performs calculations and determines that two (the integer) color charts 110 can be formed in the conveyance direction of the recording medium 100.

The length (width) in the width direction of one color chart 110 to be formed is defined as 110W. The length (width) in the width direction of the recording medium 100 is defined as 100W. As shown in FIG. 4, assume that the ratio of 100W to 110W is equal to or greater than a predetermined integer (2). In this case, the calculation section 21 performs calculations and determines that two (the integer) color charts 110 can be formed in the width direction of the recording medium 100.

As described above, the calculation section 21 determines whether the ratio of 100L (the length in the conveyance direction of the recording medium 100) to 110L (the length in the conveyance direction of one color chart 110) is greater than or equal to the integer “n”. Further, the calculation section 21 determines whether the ratio of 100W (the length in the width direction of the recording medium 100) to 110W (the length in the width direction of one color chart 110) is greater than or equal to the integer “n”. When the ratio of the length of the recording medium 100 to the length of one color chart 110 is equal to or greater than “n” (n is a positive integer), the calculation section 21 performs calculations and determines that n color charts 110 can be formed in the corresponding direction of the recording medium 100.

Although FIG. 3 and FIG. 4 illustrate the case where two color charts are formed as an example, three or more color charts 110 may be formed when the ratio of the length of the recording medium 100 to the length of the color chart 110 is 3 or greater. On the other hand, when too many color charts 110 are formed, the color charts 110 are not subjected to colorimetry in the colorimetry process and unnecessarily increases the ink consumption amount. Therefore, in consideration of a case where the ratio of the length of the recording medium 100 to the length of one color chart 110 is large, it is preferable that a predetermined upper limit value be set to the number of color charts 110 to be formed on the recording medium 100.

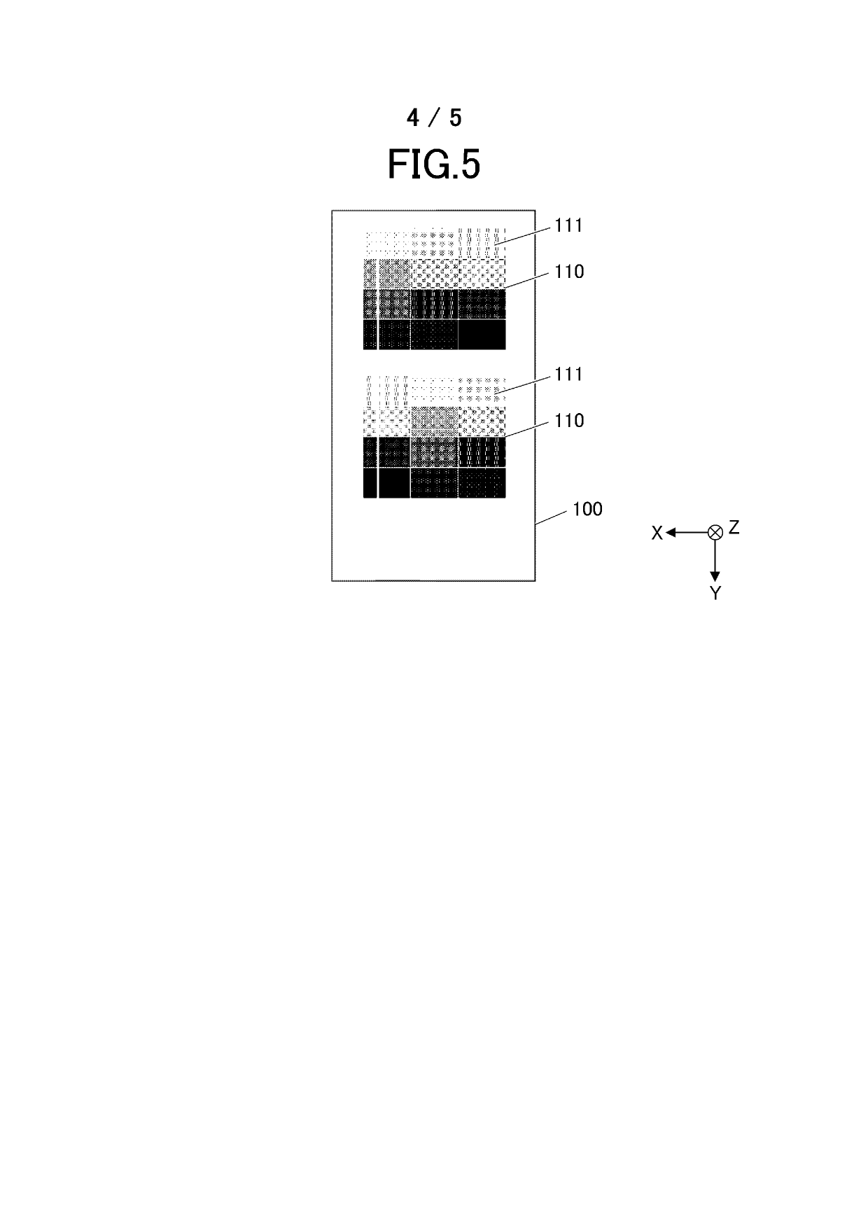

Further, particularly in a case where multiple color charts 110 are formed in the conveyance direction, it is preferable that the corresponding color patches 111 of the same kind in the respective color charts 110 are formed at different positions in the width direction, as illustrated in FIG. 5.

For example, when a nozzle of the inkjet head is clogged with ink and cannot eject ink, a white streak occurs along the conveyance direction, as shown in the color patches 111 on the left side of FIG. 5. When the white streak occurs, the colorimetry section 9 cannot perform colorimetry. For example, as illustrated in FIG. 3, when a white streak occurs in a case where the arrangements of the color patches 111 in the width direction are exactly the same among the color charts 110 arranged in the conveyance direction, all the color patches 111 having the white streak in the width direction have to be reformed.

On the other hand, when the color charts 110 are formed as illustrated in FIG. 5, even if colorimetry cannot be performed for a first color patch 111 of a first color chart 110, colorimetry can be performed for a second color patch 111 of a second color chart 110 that is the same kind as the first color patch 111. This saves time and effort for re-forming the color patches 111 and preferably suppresses an increase in ink consumption and downtime.

### (Inspection Section)

The inspection section 22 compares the read image data, which is acquired by the reading section 6 reading the color chart(s) 110, with correct image data to check whether an abnormality is present. Examples of an abnormality include a dirt on the recording medium 100, a missing part of an image, or occurrence of a white streak. The correct image data is image data of the color chart(s) 110 stored in the storage 13.

### (Determination Section)

The determination section 23 determines whether the color chart 110 formed on the recording medium 100 can be used for the colorimetry process by the colorimetry section 9, based on the inspection result by the inspection section 22. For example, even if the inspection section 22 finds an abnormality in the recording medium 100 or the color chart 110, the determination section 23 determines that the colorimetry section 9 can perform the colorimetry process if the abnormality is minor.

### (Instruction Section)

Based on the inspection result by the inspection section 22 and the determination result by the determination section 23, the instruction section 24 instructs the image forming section 5 to re-form, on the recording medium 100, only the color patch 111 that has been determined by the determination section 23 to have an abnormality and to be unusable in colorimetry by the colorimetry section 9.

When the color patch 111 is re-formed, the order of preference regarding the position of the re-formed color patch 111 is as follows: an empty area of the same recording medium 100, the back surface of the same recording medium 100, and a different recording medium 100 newly conveyed. This is because the use of a different recording medium 100 increases consumption of the recording medium 100. Further, this is because reversing the recording medium 100 with the reversing mechanism 43a and re-forming the color patch 111 on the back surface of the recording medium 100 increases the downtime due to the colorimetry process.

In re-forming the color patch 111, it is preferable that an inkjet head different from the inkjet head that formed the abnormal color patch 111 be used, because the inkjet head may have an abnormality. Furthermore, it is preferable that the color patch 111 be re-formed at multiple positions, because a re-formed color patch 111 may also have an abnormality.

### (Selection Section)

Based on the determination results of the inspection section 22 and the determination section 23, the selection section 25 selects one color patch 111 as a colometry target by the colorimetry section 9 among the color patches 111 formed on the recording medium 100. The selection section 25 sends the selection content to the colorimetry section 9.

### (Correction Section)

Based on the colorimetry result of the colorimetry section 9, the correction section 26 calculates a correction value for an image to be formed by the image forming section 5 and performs color correction.

### (Storage)

The storage 13 stores the program to be executed by the CPU, various types of setting data, and so forth. As the storage 13, for example, a hard disk drive (HDD) is used. A dynamic random access memory (DRAM) may be used together with the HDD.

### (Bus)

The bus 14 is a path for the controller 2 and other functional components to transmit and receive signals to and from each other. Each functional component may operate in accordance with control signals transmitted from a processor separate from the controller 2.

### (Colorimetry Process)

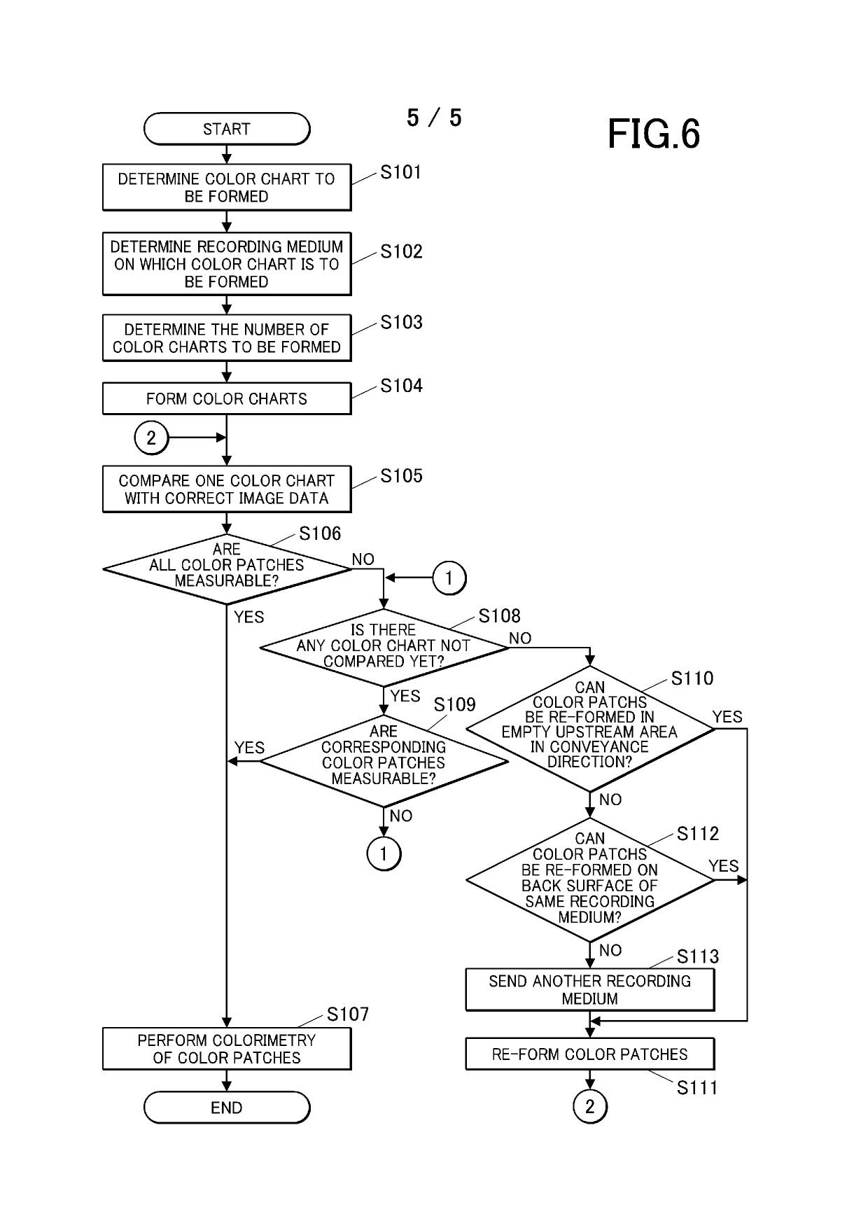

The colorimetry process to be performed by the image forming apparatus 1 will be described with reference to the flowchart of FIG. 6. The colorimetry process may be performed at a predetermined timing (e.g., a timing when a predetermined time has elapsed since the last colorimetry process or a timing when image formation processing has been performed a predetermined number of times since the last colorimetry process) or at a timing when an execution instruction by the user is received.

First, the controller 2 of the image forming apparatus 1 determines the color chart(s) 110 to be formed (step S101). For example, when the color gamut is already determined for the image to be formed in the printing process after the colorimetry process, the controller 2 determines to form the color chart 110 constituted by the color patches 111 corresponding to the color gamut of the image. On the other hand, when the image to be formed after the colorimetry process or the color gamut of the image is not determined, the controller 2 determines to form the color chart 110 constituted by the color patches 111 corresponding to the entire color gamut that can be formed by the image forming section 5.

The controller 2 determines the recording medium 100 on which the color chart 110 is to be formed (step S102). Typically, the colorimetry process and the printing process use the same kind of recording medium 100. The controller 2 determines the recording medium 100 on which the color chart 110 is to be formed, based on the user’s instruction.

The color chart 110 may be formed on multiple types of recording media 100, and the user may check the appearance of their colors and determine which recording medium 100 to use in the printing process. In this case, multiple kinds of recording media 100 are determined as the recording media 100 on which the color patterns 110 are to be formed.

The calculation section 21 acquires the length of the color chart 110 determined in step S101 and the length of the recording medium 100 determined in step S102 from the storage 13, for example, and determines the number of color charts 110 to be formed on the recording medium 100, based on these data (step S103). The length of the recording medium 100 may be acquired from the measurement result by a known sensor provided in the sheet feed section 3 or in the conveyance section 4 in the upstream of the image forming section 5 in the conveyance direction.

The controller 2 causes the image forming section 5 to form the color charts 110 of the number determined in step S103 (step S104). After formation of the color charts 110, the controller 2 performs the inspection process. The reading section 6 reads a first color chart 110 formed on the recording medium 100 and acquires read image data. The inspection section 22 compares the read image data of the first color chart 110 acquired from the reading section 6 with the correct image data stored in the storage 13 (step S105). Then, the determination section 23 determines whether colorimetry can be performed by the colorimetry section 9 for all the color patches 111 of the first color chart 110 (step S106).

When the determination section 23 determines that the colorimetry can be performed for all the color patches 111 by the colorimetry section 9 (step S106: YES), the controller 2 delivers the recording medium 100 to the first ejection section 8 and causes the colorimetry section 9 to perform colorimetry of the color patches 111 (step S107). Based on the colorimetry result, the correction section 26 corrects the image forming section 5 by calculating a correction value and ends the colorimetry process.

When the determination section 23 determines that the colorimetry process by the colorimetry section 9 cannot be performed for all the color patches 111 (step S106: NO), the controller 2 determines whether there is a second color chart 110 that has not been compared with the correct image data yet (step S108).

When there is a second color chart 110 on the recording medium 100 that has not been compared with the correct image data (step S108: YES), the controller 2 reads the second color chart 110 with the reading section 6. Next, the inspection section 22 inspects the second color patch 111 among the color patches 111 of the second color chart 110 for an abnormality. The second color patch 111 is the same type as the first color patch 111 that was determined not to be subjected to colorimetry by the colorimetry section 9. Based on the inspection result of the inspection section 22, the determination section 23 determines whether the second color patch 111 can be subjected to colorimetry by the colorimetry section 9 (step S109).

When the determination section 23 determines that colorimetry by the colorimetry section 9 cannot be performed for the corresponding second color patch 111 (step S109: NO), the controller 2 proceeds to step S108 and determines whether there is another second color chart 110. On the other hand, when the determination section 23 determines that colorimetry can be performed by the colorimetry section 9 (S109: YES), the selection section 25 selects, from the color patches 111 in the first color chart 110 and the second color chart 110, the color patches 111 determined to be subjected to colorimetry by the determination section 23, and sends the selected color patches 111 to the colorimetry section 9. Then, the controller 2 proceeds to step S107, and the colorimetry section 9 performs colorimetry.

When there is a color patch 111 for which colorimetry by the colorimetry section 9 cannot be performed and there is no second color chart 110 that has not been compared with the correct image data yet (step S108: NO), the instruction section 24 instructs the conveyance section 4 and the image forming section 5 to re-form the color patch 111. Specifically, the controller 2 determines whether it is possible to re-form the color patch 111 that has been determined in the previous step not to be subjected to colorimetry by the colorimetry section 9 in the empty area in the upstream of the image forming section 5 in the conveyance direction on the same recording medium 100 (step S110).

When determining that the color patch 111 can be re-formed in the empty area in the upstream in the conveyance direction of the recording medium 100 (step S110: YES), the controller 2 re-forms the color patch 111 in the empty area (step S111) and proceeds to step S105. When the color patch 111 cannot be re-formed in the empty area in the upstream in the conveyance direction of the recording medium 100 (step S110: NO), the controller 2 determines whether the color patch 111 can be re-formed on the back surface of the same recording medium 100 (step S112). The controller 2 determines whether the color patch 111 can be re-formed on the back surface of the same recording medium 100, based on at least one of the paper type, sheet thickness, ink type, image density, and ink amount, for example. When determining that the color patch 111 can be re-formed on the back surface of the same recording medium 100 (Step S112: YES), the controller 2 conveys the recording medium 100, causes the reversing mechanism 43a to reverse the recording medium 100, and proceeds to Step S111 and Step S105.

When determining that the color patch 111 cannot be re-formed on the back surface of the recording medium 100 (step S112: NO), the controller 2 delivers the recording medium 100 of the same kind from the sheet feed section 3 (step S113) and proceeds to step S111 and step S105.

### Effects of Embodiment

As described above, according to the present embodiment, the controller 2 of the image forming apparatus 1 includes the inspection section 22 that inspects each of the color patches 111 for an abnormality, based on the image data of the color patches 111 acquired from the reading section 6. The controller 2 further includes the determination section 23 that determines whether the color patch 111 can be subjected to colorimetry by the colorimetry section 9, based on the inspection result of the inspection section 22. The controller 2 further includes the instruction section 24 that causes the image forming section 5 to re-form only the color patch 111 that has been determined by the determination section 23 not to be subjected to colorimetry by the colorimetry section 9. According to such a configuration, even if all the corresponding color patches 111 have abnormalities and unsatisfactory qualities, the instruction section 24 instructs to re-form only the color patch 111. Thus, colorimetry of the necessary color patch can be efficiently performed.

The controller 2 further includes the calculation section 21 that calculates the number of color patches 111 that can be formed on the recording medium 100. The calculation section 21 acquires the lengths of the recording medium 100 in the conveyance direction and the width direction and the lengths of the color chart 110 in the conveyance direction and the width direction. When the length 110L of the color chart 110 in the conveyance direction is equal to or shorter than half the length 100L of the recording medium 100 in the conveyance direction, the calculation section 21 determines that multiple color charts 110 can be formed. When the length (width) 110W of the color chart 110 in the width direction is equal to or shorter than half the length (width) 100W of the recording medium 100 in the width direction, the calculation section 21 determines that multiple color charts 110 can be formed. According to such a configuration, multiple color charts 110 are formed on one recording medium 100, based on the sizes of the recording medium 100 and the color charts 110. This increases a possibility that the colorimetry process can be completed without re-forming the color patches 111 and thereby increases efficiency of the colorimetry process.

When the calculation section 21 determines multiple color charts 110 can be formed in the conveyance direction of the recording medium 100, the controller 2 arranges the color patches 111 such that the corresponding color patches 111 among multiple color charts 110 are formed at different positions in the width direction. Such a configuration increases the possibility that the colorimetry process can be completed without re-forming a color patch 111, even when an abnormality (e.g., a white streak extending in the conveyance direction) occurs on the color patch 111. Thus, the efficiency of the colorimetry process is increased.

When the inspection section 22 determines that the first color patch 111 of the first color chart 110 has an abnormality, the inspection section 22 inspects the second color patch 111 of the second color chart 110 that is the same type as the first color patch 111 for an abnormality. Such a configuration increases the possibility that the colorimetry process can be completed without re-forming the color patch 111.

Further, when the inspection section 22 determines that both of the color patches 111 have abnormalities, the instruction section 24 instructs the image forming section 5 to re-form the color patch 111 in an empty space on the front side of the recording medium 100 on which both of the color patches 111 have been formed. Such a configuration relatively increases efficiency of the colorimetry process while suppressing the consumption of the recording medium 100.

The instruction section 24 may instruct the image forming section 5 to re-form the color patch 111 on the second side of the recording medium 100 on which the first and second color patches 111 have been formed. According to such a configuration, the colorimetry process can be performed while suppressing the consumption of the recording medium 100.

The instruction section 24 may instruct the image forming section 5 to re-form the color patch 111 on a recording medium 100 different from the recording medium 100 on which the first and second color patches 111 have been formed. Such a configuration can avoid a situation in which the colorimetry process cannot be performed owing to an abnormality of the recording medium 100 on which the first and second color patches 111 have been formed.

The instruction section 24 may cause a second inkjet head to re-form the color patch 111, the second inkjet head being different from a first inkjet head that formed the color patch 111. Such a configuration can avoid a situation in which the colorimetry process cannot be performed owing to an abnormality of the inkjet head that forms the color patch 111.

The instruction section 24 may instruct the image forming section 5 to re-form multiple color patches 111, based on the calculation result of the calculation section 21. According to such a configuration, there is no need to again re-form color patches 111 even if a re-formed color patch 111 includes an abnormality. Thus, it is possible to avoid an increase in the colorimetry process time.

Further, the reading section 6 may be an inline sensor provided on the downstream of the image forming section 5 in the conveyance direction. According to such a configuration, reading the color charts 110 by the reading section 6 and re-forming the color patches 111 based on the reading result can be performed sequentially. This reduces time required for the colorimetry process.

Further, the inspection section 22 compares the image data with the correct image data to detect dirt, a missing part, or a streak on the image data. By detecting dirt, a missing part, or a streak by the reading section 6, it is possible to detect an abnormality without stopping the conveyance section 4 and thereby restrain a decrease in productivity.

### Other Configurations

Although the embodiment of the present disclosure has been described in detail, the present disclosure is not limited to the above-described embodiment. The embodiment of the present disclosure can be modified in various ways within the scope equivalent to the scope of the invention described in the claims.

For example, although the image forming apparatus 1 in the above description is an inkjet recording apparatus that includes the image forming section 5 provided with an inkjet head as an example, the image forming apparatus 1 is not limited thereto. For example, the image forming apparatus 1 may be a laser printer in which the image forming section 5 forms an image by the electrophotographic method. As described above, the present disclosure is applicable to various image forming apparatuses 1 that adjust the image forming section 5 by forming and reading color patches 111.

Although the conveyance section 4 conveys the recording medium 100 and the printed material 200 using the conveyance drum 43 in the above description as an example, the present disclosure is not limited thereto. For example, the recording medium 100 and the printed material 200 may be conveyed by an endless belt.

Although the image forming apparatus 1 includes the controller 2, the conveyance section 4, the reading section 6, and the colorimetry section 9 in the above description as an example, the present disclosure is not limited thereto. As described above, the image forming apparatus 1 should include the image forming section 5. The present disclosure is applicable to an image forming system in which an apparatus(es) other than the image forming apparatus 1 includes components except the image forming section 5.

Although the HDD is used as a computer-readable medium for storing the program of the present disclosure as an example, the present disclosure is not limited thereto. As another computer-readable medium, a portable recording medium, such as a CD-ROM, can be applied. Further, a carrier wave is also applied as a medium for providing data of the program of the present disclosure via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms an image on a recording medium;
a reader that reads the image formed on the recording medium;
a colorimeter that performs colorimetry of the image formed on the recording medium; and
a hardware processor, wherein:
based on image data of multiple color patches obtained from the reader, the hardware processor inspects each of the color patches for an abnormality,
based on the inspection result, the hardware processor determines whether the colorimeter can perform colorimetry of each of the color patches, and
the hardware processor causes the image former to re-form only a color patch determined not to be subjected to colorimetry by the colorimeter.

2. The image forming apparatus according to claim 1, wherein:
the hardware processor calculates a number of color patches that can be formed on the recording medium,
the hardware processor obtains lengths of the recording medium in a conveyance direction and in a width direction perpendicular to the conveyance direction and lengths of a color chart consisting of the color patches in the conveyance direction and in the width direction, and
when (i) the length of the color chart in the conveyance direction is equal to or shorter than half the length of the recording medium in the conveyance direction or (ii) the length of the color chart in the width direction is equal to or shorter than half the length of the recording medium in the width direction, the hardware processor determines that multiple color charts can be formed.

3. The image forming apparatus according to claim 2, wherein, when determining that multiple color charts can be formed in the conveyance direction on the recording medium, the hardware processor arranges the color patches such that color patches corresponding to each other and belonging to different color charts are formed at different positions in the width direction.

4. The image forming apparatus according to claim 2, wherein, when determining that a first color patch in a first color chart consisting of multiple color patches has an abnormality, the hardware processor inspects a second color patch for an abnormality in a second color chart different from the first color chart, the second color patch being an identical type as the first color patch.

5. The image forming apparatus according to claim 4, wherein, when determining that the first and second color patches have abnormalities and that the first and second color patches cannot be subjected to colorimetry by the colorimeter, the hardware processor instructs the image former to re-form a color patch corresponding to the first and second color patches in an empty area on a first surface of the recording medium on which the first and second color patches have been formed.

6. The image forming apparatus according to claim 4, further comprising a reversing mechanism in a downstream of the image former in the conveyance direction, the reversing mechanism being configured to turn over the recording medium to change imaging forming surfaces of the recording medium and cause the recording medium to pass through the image former again, wherein
when determining that the first and second color patches have abnormalities and that the first and second color patches cannot be subjected to colorimetry by the colorimeter, the hardware processor instructs the image former to re-form a color patch corresponding to the first and second color patches on a second surface of the recording medium opposite a first surface on which the first and second color patches have been formed.

7. The image forming apparatus according to claim 4, wherein, when determining that the first and second color patches have abnormalities and that the first and second color patches cannot be subjected to colorimetry by the colorimeter, the hardware processor instructs the image former to re-form a color patch corresponding to the first and second color patches on a recording medium different from the recording medium on which the first and second color patch have been formed.

8. The image forming apparatus according to claim 5, wherein:
the image forming section includes multiple inkjet heads, and
the hardware processor causes a second inkjet head different from a first inkjet head that formed the first and second color patches having abnormalities to re-form the color patch corresponding to the first and second color patches.

9. The image forming apparatus according to claim 5, wherein the hardware processor instructs the image former to re-form multiple color patches, based on the calculation result.

10. The image forming apparatus according to claim 1, wherein the reader is an in-line sensor provided in a downstream of the image former in the conveyance direction.

11. The image forming apparatus according to claim 1, wherein the hardware processor compares the image data with correct-answer image data to detect dirt, a missing part, or a streak in the image data.

12. An image forming method for an image forming apparatus that includes: an image former that forms an image on a recording medium; a reader that reads the image formed on the recording medium; a colorimeter that performs colorimetry of the image formed on the recording medium; and a hardware processor, the method comprising:
based on image data of multiple color patches obtained from the reader, inspecting each of the color patches for an abnormality,
based on the inspection result, determining whether the colorimeter can perform colorimetry of each of the color patches, and
causing the image former to re-form only a color patch determined not to be subjected to colorimetry by the colorimeter.

13. A non-transitory computer-readable storage medium storing a program for a computer of an image forming apparatus that includes: an image former that forms an image on a recording medium; a reader that reads the image formed on the recording medium; and a colorimeter that performs colorimetry of the image formed on the recording medium, the program causing the computer to:
inspect, based on image data of multiple color patches obtained from the reader, each of the color patches for an abnormality,
determine, based on the inspection result, whether the colorimeter can perform colorimetry of each of the color patches, and
cause the image former to re-form only a color patch determined not to be subjected to colorimetry by the colorimeter.
